(19) United States
(12) Patent Application Publication
(10) Pub. No.: US 2021/0064012 A1
(43) Pub. Date: Mar. 4, 2021

(54) Method for Monitoring an Operationally Correct Functioning of a Plant Control System

(71) Applicant: Siemens Aktiengesellschaft, Muenchen (DE)

(72) Inventor: Harald Schweigert, Wien (AT)

(21) Appl. No.: 17/004,858

(22) Filed: Aug. 27, 2020

(30) Foreign Application Priority Data
Aug. 29, 2019 (EP) 19194242

(51) Int. Cl. G05B 19/418

(52) U.S. Cl. CPC G05B 19/41865; G05B 2219/25151; G05B 19/41815; G05B 19/4183

(57) ABSTRACT

A method for monitoring an operationally correct manner of functioning of a plant control system that includes at least one control unit, wherein different operating states are assumed by the control system, where each time a change occurs in the operating state of the control system, respective latest current and/or voltage values are measured at each output channel for respective associated load circuits and stored with the respective latest operating state, where the latest recorded current and/or voltage measurement values are then compared with current and/or voltage values of a preceding measurement, in addition a check is performed to determine whether a predefined tolerance range is exited based on the comparison of the latest recorded current and/or voltage measurement values with the current and/or voltage values of the at least one preceding measurement, and the respective load circuit in which the predefined tolerance range is exited is then displayed.

### FIELD OF THE INVENTION

The instant invention relates generally to the field of electrical engineering and, more particularly, to the field of power electronics and power electronics circuits, and more specifically, to a method for monitoring an operationally correct manner of functioning of a plant control system, wherein in addition to at least two load circuits, the control system comprises at least one control unit as well as a clocked power supply, where the at least two load circuits, each of which has at least one load unit (e.g. sensor, actuator, relay, contactor, solenoid valve, servomotor, etc.), are supplied with a supply voltage and/or a supply current by the clocked power supply via at least two output channels, to each of which a load circuit is connected, and where different operating states are assumed by the control system of the plant while the plant is functioning in an operationally correct manner, an operating state being brought about by a predefinable combination of output signals of the control unit.

### 2. DESCRIPTION OF THE RELATED ART

Complex machines and/or plants are currently deployed in many sectors, such in industrial production and manufacture, in energy generation and distribution, in automation technology, or in building management. What is understood as a plant in this context is a carefully planned, systematic combination of components (e.g., machines, devices and/or appliances) that coexist in a spatial relationship and that are linked to one another in terms of functionality, control engineering and/or safety issues. Technical facilities of the type, such as production plants, manufacturing plants or energy generation and energy distribution plants, or the components thereof exhibit an increasing degree of complexity. To ensure efficient operation of technical plants and complex machines, it is therefore a common practice to make use of control systems in which operating or process parameter values of the plant or machine are measured by sensor or measurement units. Depending on the measured operating or process parameter values, actuator units or other load units (e.g., contactors, solenoid valves, visual or audible warning signals, motor units, or display units) are controlled via output signals of the control system to change, e.g., operating or process parameters of the plant or machine. With the control system, the aim is to ensure the machine or plant operates with maximum autonomy and independently of human interventions in accordance with a desired, operationally correct functionality.

Typically, the control system has a control unit for the purpose of evaluating values measured by the sensor or measurement units as well as for controlling the actuator units (e.g., servomotor, warning signal, or display unit) or for switching further load units (e.g., relays, contactors or solenoid valves). The control unit, which may be formed, e.g., as a computing device known as a programmable logic controller (PLC), as a microcontroller or as an industrial PC, provides output signals, e.g., in the form of digital control commands, analog control commands or as control commands via a data link (e.g., via the Process Field Network (Prof inet)) to assure the ongoing and orderly operation of the plant. With the aid of the output signals of the control unit, different load units or actuator units can be controlled, for example, in accordance with industrial process control requirements. Thus, actuator units, such as servomotors, warning signal equipment or display units, can be activated or controlled or further load units, such as contactors, relays, solenoid valves, which are actuated via a device such as an electromagnet, can be attached or detached from the system.

A predefinable combination of output signals of the control unit, i.e., digital, analog and/or control commands that are transmitted by the control unit via a data link can, for example, bring about an operating state of the control system or the plant or machine. The operating state constitutes an operating condition of the plant or machine that is defined by the control unit via the output of specific output signals and via which the load units are switched accordingly in the load circuits. In other words, contingent on requirements during the operation of the plant or machine, combinations of output signals are transmitted by the control unit to the load units, in which case the combinations may be predefinable, e.g., via a control program executing in the control unit. The respective load units (e.g., actuator, relay, contactor, solenoid valve or servomotor) are controlled accordingly by the output signals, i.e., attached or detached or activated or deactivated. An operating state can therefore be invoked repeatedly by the control unit, i.e., over and over again upon application of the same combination of output signals to the load units in the load circuits.

A control system of the foregoing type further comprises at least one clocked power supply (e.g., a switched-mode power supply) via which an unstabilized input voltage, in most cases an alternating-current voltage, is converted into a constant output voltage, in most cases a direct-current voltage (e.g., 24 volts), for supplying the load units of the control system. A power supply of said type, such as the SITOP PSU8600 of the company Siemens, may have, for example, at least two or more outputs for directly connecting load circuits, where the outputs are used as output channels via which the load circuits and consequently the load units of the control system are supplied with current or voltage.

Alternatively, it is possible to make use of a clocked power supply to which a module (e.g., a switchable protection unit) can be connected, for example, via an output of the power supply. Then, for example, at least two separately switchable output branches are made available as output channels by the module. A load circuit having at least one load or load unit or having a group of load units can be connected to each of the output channels. The load or the load circuit is then supplied via the respective output channel with a supply voltage (e.g., 24 volts) and/or a supply current that is provided by the clocked power supply.

Output signals can likewise be used by the control unit for controlling the output channels, i.e., in order to switch on/off the voltage and/or power supply of a load circuit. It is furthermore possible, for example, for the supply voltage or the supply current in the output channels (i.e., the supply voltage or the supply current for the load circuit connected at a given time) to be influenced by the control unit. A data interface can be provided for example for transmitting the corresponding output signals and/or control commands between the control unit and the output channels. Profinet (Process Field Network), the open Industrial Ethernet standard of the PROFIBUS User Organization, may be used for this data interface, for example. Alternatively, the control unit may also control the clocked power supply and/or the output channels, for example, via analog setpoint values that are predefined for the output channels.

In a power supply having at least two output channels (e.g., in the SITOP PSU8600), voltage and current can, for example, be set and monitored individually for each output channel (e.g., via output signals of the control unit). This means that, e.g., the respective latest supply or load current set for each output channel, as well as the respective latest supply voltage set for the respective connected load circuit, can be measured and monitored. Similarly, the respective supply or load current as well as the supply voltage for load circuits connected via output branches of an additional module can be measured and monitored. This enables for example a current consumption and a voltage required for the supply to be determined for the respective load circuit, where the current consumption and the voltage in the respective load circuit is subject to variation due to control and switching actions of the control unit of the control system. In other words, by activating or deactivating actuator units (e.g., switching on a light signal unit, warning device, etc., varying a motor rotational speed, etc.) and/or attaching and detaching further load units (e.g., contactors or solenoid valves) in accordance with the requirements of ongoing operation, i.e., by changing the operating state in the plant or machine, it is possible to vary the respective current consumption as well as the voltage in the respective load circuit.

If a plant or complex machine has been placed into operation following its installation, expansion, etc. and if, for example, faults which may occur due to the installation and/or expansion (e.g. faults in the wiring of the load units, etc.) can be ruled out, then it is important to guarantee a smooth, reliable and functionally appropriate operation of the plant or machine and to be able to quickly detect and localize imminent malfunctions or occurring faults.

One possibility, for example, is to provide the individual load circuits of the control system or the plant with mechanical and/or electronic protection units. If, e.g., an overload then occurs in a load circuit, then the load circuit is switched off by the protection unit. Troubleshooting can then be limited, e.g., to the disconnected load circuit of the control system. However, this approach offers only a very crude way to evaluate and localize faults that may occur during live operation, such as failure of a load unit or frayed cables. Imminent malfunctions (e.g., due to aging of load units, damaged cables, or short-circuited cables) of the plant or machine may hardly be detected or even not be detected at all, for example, as a result of a deployment of protection units.

Furthermore, there are currently approaches, for example, enabling impending or imminent malfunctions of plant or machine components to be predicted in advance with relatively high probability. Admittedly, these approaches were limited in most cases to mechanical components of plants or machines, such as ball bearings. Here, it may already be specified, e.g., by the manufacturer which acoustically measurable noise frequencies or frequencies detectable via vibration sensors may be associated with certain parts (e.g., end plate, outer ring, inner ring or balls) of the mechanical components, such as the ball bearing. These values are based, e.g., on a rated rotational speed and can be converted accordingly to a currently sensed rotational speed. Changes for example can then be identified by determining noise and/or vibration frequencies occurring at the present time or an associated amplitude and the part of the mechanical component or ball bearing responsible for this in a given case can also be determined. In other words, damage to or failure of a mechanical component, such as e.g. a ball bearing, can be detected and rectified in a timely manner. Similar approaches for electrical and/or electronic components of a plant or machine, such as sensor units, actuator units, relays, contactors or solenoid valves, which are particularly used in control systems in plants or complex machines, are hardly known.

That said, however, a modular power distribution and protection system allowing centralized monitoring of decentralized plants is known, e.g., in the shape of the REX system of the German company E-T-A Elektrotechnische Apparate GmbH. This system comprises at least one input module for connecting to a clocked power supply, as well as at least one protection module having one or two channels for connecting and protecting a load circuit. Dynamic plant information and measurement values (e.g., the latest recorded voltage and current values in load circuits that are connected via one or more protection modules, or reason for deployment of a protection module) can be determined via the input module, for example, and read out by a higher-ranking control unit via a data link. In addition, a rated current and a limit value for a respective current value in the load circuit can be set, e.g., in the protection modules. With the aid of the power distribution and protection system, it is in fact possible to detect extreme defects, such as short-circuits in the wiring of a load circuit, short-circuits or overcurrents in a load circuit, in particular during the ongoing operation of a plant. Impending faults or malfunctions of load units which, although constraining the ongoing operation of the plant or machine, do not obstruct or prevent the same, or faults that lead to only minor overcurrents or current reductions compared to a nominal condition are hardly detectable or very difficult to detect with the system. That is, such faults or malfunctions mostly go undetected, for example, until the failure of or damage to a load unit, etc. Furthermore, the system may also lead to increased overhead and costs, e.g., for plant planning and maintenance by reason of its modular design.

### SUMMARY OF THE INVENTION

In view of the foregoing, it is therefore an object of the invention to provide a method for monitoring an operationally correct functioning of a control system as well as of the associated load circuits of a plant via which malfunctions as well as imminent faults and/or failures of load units and/or their feed lines can easily be detected at an early stage in load circuits.

This and other objects and advantages are achieved in accordance with the invention by a method for monitoring an operationally correct manner of functioning of a plant control system, where the control system comprises at least one control unit and a clocked power supply in addition to at least two load circuits, each of which has at least one load unit or one power-consuming appliance (e.g., contactor, solenoid valve, sensor unit, or actuator unit). The at least two load circuits, each having at least one load unit, are supplied with a supply voltage and/or a supply current by the clocked power supply via at least two output channels, where the at least two output channels may be formed as at least two direct outputs of the power supply or as at least two output branches of a module connected to the power supply. Furthermore, different operating states are assumed by the control system during an operationally correct functioning of the plant, where an operating state is brought about by a predefinable combination of output signals of the control unit.

In accordance with invention, the method comprises at least detecting a change in the operating state of the plant control system, measuring the respective latest current and/or voltage values at each of the at least two output channels for the respective associated load circuits, storing the latest recorded current and/or voltage measurement values together with the respective operating state of the control system, comparing the latest recorded current and/or voltage measurement values with current and/or voltage values of at least one preceding measurement, where the respective operating state of the current and/or voltage values of the at least one preceding measurement reveals a correspondence with the respective operating state of the latest recorded current and/or voltage measurement values, i.e., from the stored data of preceding measurements at the respective output channels for supplying power to the load circuits, those current and/or voltage values are determined that were measured in an operating state which at least largely coincides with the respective operating state of the latest recorded current and/or voltage measurement values or reveals an identical, almost identical, like or similar combination of output signals of the control unit. The method in accordance with the invention further comprise checking whether a predefined tolerance range is exited based on the comparison of the latest recorded current and/or voltage measurement values with the current and/or voltage values of the at least one preceding measurement, and displaying the respective load circuit in which the predefined tolerance range is exited in the respective operating state of the latest recorded current and/or voltage measurement values.

The main aspect of the method in accordance with the invention presents the possibility to easily detect malfunctions in load circuits and/or impending faults or failures of load units, their feed lines, etc. at an early stage and enables a correspondingly rapid localization of the these failures. To this end, the respective current and/or voltage measurement values for previously completed operating states (i.e., for the output signal combinations produced in each case by the control unit) are measured at the output channels and then stored, where the load circuits having the respective load units (e.g. sensor, actuator, contactors, relays, solenoid valves, etc.) are connected at the output channels. The latest recorded measurement values for current and voltage are then compared with measurement values of preceding measurements, where those measurements of current and/or voltage values that were measured during an identical or similar operating state that is most directly comparable with the present situation or the present operating state are filtered out. Ideally, current and/or voltage values that were measured in the same operating state, i.e., with the same combination of output signals of the control unit, will be found in the preceding measurements.

In order to detect deviations and/or changes, the current and/or voltage values of preceding measurements for the respective operating state are now compared with the latest recorded measurement values. By virtue of the predefined tolerance range, it is possible to detect substantial or significant deviations, e.g., in the current consumption or in the voltage values that were measured at the output channels or for the respective load circuits. In this simple way, the operator of the plant or machine can receive indications as to which load circuit, load unit or load groups, may not be functioning in an operationally correct manner and, if necessary, check these in order to be able, for example, to rectify impending faults, e.g., due to aging of individual load units, in good time.

In an advantageous embedment of the method in accordance with the invention, the latest values of parameters and/or signals at signal inputs of the control unit and/or the latest values of environmental and plant parameters are measured and stored in addition to the latest recorded current and/or voltage measurement values of the respective operating state. If, for example, a large number of preceding measurements of current and/or voltage values for the respective operating state are available with which the latest measured current and/or voltage measurement values can be compared, then the additional parameter and signal values at the signal inputs of the control unit (e.g., values of temperature sensors, pressure sensors, or rotational speed sensors, function signals of proximity sensors, light signals, or alarm signals) and/or the latest recorded values of environmental and plant parameters (e.g., temperature values, pressure values, or rotational speed values) can be utilized for a further filtering of the comparison data that was determined in preceding measurements. By taking these so-called secondary parameters into account, i.e., the parameters and/or signals of the signal inputs of the control unit and where appropriate environmental and further plant parameters, the comparison of the latest recorded measurement data for current and voltage for the respective operating state is ideally performed only with that data of preceding measurements that was determined under approximately similar conditions. This ideally results in a reduction in load circuits functioning in an operationally correct manner being indicated as faulty or in false alarms, because differences in the current and voltage measurement values that may be caused, e.g., by external influences (e.g., temperature) are minimized.

It is furthermore favorable if a maximum permissible deviation is predefined for an evaluation of the correspondence between the respective operating state of the latest recorded current and/or voltage measurement values and the operating state of the current and/or voltage values of at least one preceding measurement. In this simple way, it is ensured that the comparison of the latest recorded current and/or voltage measurement values will be based on current and/or voltage values of preceding measurements that were measured in operating states that coincide to a large extent with the operating state in which the latest measurement values were determined. Malfunctions and/or impending faults in load circuits can be detected with a high degree of probability only if there is a high level of correspondence of the operating states and where applicable of the secondary parameters in which the respective measurement values were produced. In the case of large, complex plants and/or machines (e.g., in the process industry), an operating state can furthermore be defined by a multiplicity of output signals of the control unit. In plants of the foregoing type or associated control systems, it may be beneficial to allow a maximum permissible deviation in the evaluation of the correspondence of operating states to obtain a corresponding number of comparison values.

The predefined tolerance range for the comparison of the latest recorded current and/or voltage measurement values with the current and/or voltage values of at least one preceding measurement in the respective operating state can advantageously be adjusted. Ideally, the adjustability of the tolerance range enables fluctuations in the current and/or voltage measurement or also slight drifts to be compensated for in order, e.g., to prevent unnecessary alarms or false alarms. By implementing the method in accordance with the disclosed embodiments at regular intervals, it is possible, for example, to detect typical fluctuations in load circuits of the plant or machine and to adjust the tolerance range accordingly in order to avoid, e.g., false calls due to a too narrowly chosen tolerance range or faults and/or malfunctions in load circuits being overlooked due to a too broadly chosen tolerance range.

The predefined tolerance range may be specified, for example, in the form of a percentage or in the form of an absolute range. A combination of both is also possible. A tolerance range may furthermore be predefined for all measurement values that are to be checked or specific or load-circuit-specific tolerance ranges may also be predefined for the respective measurement values (e.g., for current and voltage values).

After the change in operating state has been detected, a predefinable waiting time is beneficially observed prior to the measurement of the respective latest current and/or voltage values at each of the at least two output channels. In this simple way, effects of fluctuations in the current consumption or in the voltage, for example, due to the change in operating state, on the measurement of the respective latest current or voltage measurement value can be eliminated as far as possible. Fluctuations of this type can be triggered, for example, as a result of switching operations performed in load units due to the change in operating state (e.g., attachment or detachment of a load unit, changing of a control variable in an actuator, or stabilization phases in thermal resistors).

The change in operating state may possibly also lead to an activation of or a change in the supply voltage or the supply current in a load circuit or in an output channel, thereby triggering fluctuations that may lead to incorrect measurement values for current and/or voltage. The predefinable waiting time may be chosen, for example, such that a stable current value having, e.g., a relatively minor fluctuation (e.g., 3% deviation in one second) has been reached for the measurement of the current values at the respective output channel. A default value for the predefinable waiting time can be derived, e.g., from preceding measurements, e.g., based on a graphical representation of a variation of the measurement values over time. This enables, e.g., waiting times in load units or load circuits to be reduced to a minimum without a significant stabilization time. In load units having relatively long stabilization times, a safety factor may be provided, for example, in addition to the predefinable waiting time to obtain stable measurement values.

It may furthermore be useful to determine current and/or voltage measurement values for series or sequences of multiple individual operating states over time, e.g., instead of determining the latest current and/or voltage measurement values for individual operating states, and to use these as a basis for a comparison with current and/voltage values of earlier measurements. It may happen, for example, that an operating state changes before a stabilization process of at least one load unit or of a power-consuming appliance has terminated. In other words, a change is made by the control unit, e.g., at another point of the plant or machine whilst a longer-lasting stabilization process of a power-consuming appliance or load unit has not yet been terminated and where the load unit continues to remain switched on during this change in operating state. As a result of the measurement and the comparison of operating state sequences, e.g., corresponding false alarms can be prevented or reduced.

In addition or alternatively, it is also conceivable, in particular for the measurement of the latest current values, that after detection of the change in operating state, the respective latest current value that is to be determined in each case at the at least two output channels is measured at predefinable intervals within a predefinable period of time, and that an average value is formed from the current values measured in the predefinable period of time as the latest current measurement value for the respective operating state. That is, the latest recorded current measurement value for the respective latest operating state is formed as an average value from a plurality of current values that are measured over a predefinable period of time or integration time (e.g., 0.1 second or 10 seconds). Alternatively, a different type of mathematical filtering may be provided to reduce the effect of current consumption fluctuations, in particular in the event of changes in the supply voltage or as a result of switching operations caused by the change in operating state, in the load circuit or to reduce noise during the determination of the current measurement values.

It is also advantageous if the current and/or voltage values of the at least one preceding measurement are measured on the same plant or on the same control system as the latest recorded current and/or voltage measurement values. In this way, it becomes possible to ensure that the measurement data of different measurements is determined to a large extent under the same or similar conditions. This approach can be applied, e.g., in the case of plants and machines that are produced or adapted as one-offs or as operator-specific solutions.

Alternatively, the current and/or voltage values of the at least one preceding measurement can also be measured on a plant of identical or similar configuration or a control system of identical or similar configuration. This approach can be applied, for example, in the case of series-produced plants and/or machines that are deployed, e.g., without major operator-specific modifications. In particular, when a plurality of plants or machines of identical or similar configuration are in operation in the field, a multiplicity of measurement data can be collected in this way. This allows impending faults, malfunctions and/or deteriorating load units in load circuits in the case of individual plants and/or machines to be detected both at an earlier stage and with greater accuracy and possibly failures to be prevented.

Advantageously, the measured current and/or voltage values can be stored together with the respective associated operating states in the control unit of the plant or machine control system. In this way, the method in accordance with the disclosed embodiment of the invention can be performed, e.g., directly by the control unit in the form of an analysis and evaluation function that supplies information concerning possible malfunctions or impending faults, in the load circuits of the control system of the plant or machine, such as in the form of alarm messages. The current and voltage measurement data can be evaluated, for example, online, i.e., measurement data is acquired continuously during operating state changes and compared for conspicuous changes with current and voltage data of preceding measurements in comparable or corresponding operating states. Alternatively, the evaluation of the latest recorded measurement data, i.e., the comparison with data of preceding measurements in corresponding operating states as well as the check to determine whether there is a departure from the predefined tolerance range, may also be performed with a time delay.

Alternatively or in addition, the measured current and/or voltage values can be transferred together with the respective associated operating states to an evaluation and/or data processing unit and stored therein. The measurement values can thus be very easily utilized for checking a plurality of plants or machines of identical or similar configuration. The evaluation of the latest recorded measurement data can, for example, again occur online or with a time delay (i.e., offline). Storing the latest measurement values and in particular performing an offline evaluation of the measurement values at a later time provides a very simple way to allow extended analysis and evaluation options. In this way, it becomes possible, e.g., for measurement results to be presented graphically or developments over time in the plant or machine to be assessed. In this way, e.g., imminent malfunctions in load circuits or changes that may lead to malfunctions of the plant or machine can be detected in a timely manner and rectified if necessary.

In an advantageous embodiment of the method in accordance with the invention, a start signal is sent to the evaluation and/or data processing unit by the control unit prior to a transfer of the latest recorded current and/or voltage measurement values and the respective associated operating state. This enables, e.g., a stable measurement of the latest current and voltage values at the output channels following a change in operating state as well as a start of the data transfer to be communicated to the evaluation and/or data processing unit by the control unit. Particularly, in an online evaluation, the start signal can also notify the start of a further evaluation cycle to the evaluation and/or data processing unit. Ideally, a return signal can be sent to the control unit by the evaluation and/or data processing unit when the latter is, e.g., ready for a next evaluation cycle.

Ideally, the steps of the method in accordance with the invention are performed during the ongoing operation of the plant or machine. That is, during operation of the plant or machine, the respective latest current and/or voltage measurement values are determined for every detected change in operating state and stored together with the respective latest operating state in order to be then compared online or offline with current and/or voltage values from at least one earlier measurement that has an identical or at least a similar operating state. The plant or machine is therefore advantageously monitored constantly for potentially occurring faults or imminent malfunctions in load circuits or for changes that may lead to malfunctions of the plant or machine.

Alternatively or in addition, the steps of the method may also be performed in a test phase in the form of a test program. Here, operating states predefined by the control unit are invoked, for example, by the test program and the respective latest current and/or voltage measurement values associated with these are measured and then stored together with the operating state invoked in each case. Subsequently, the latest recorded current and/or voltage measurement values can then be compared with current and/or voltage measurement values from earlier measurements in the same or similar operating states. The current and/or voltage measurement values may originate, for example, from preceding passes through the test program. However, recourse may also be had to current and/or voltage measurement values from measurements that were taken during the ongoing operation of the plant or machine insofar as these relate to operating states that largely coincide with the operating states predefined in the test program.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWING

The invention is explained below in an exemplary manner with reference to the attached figures, in which:

FIG. 1 shows a schematic and exemplary layout of a plant control system for performing the inventive method for monitoring an operationally correct manner of functioning of the control system of a plant; and

FIG. 2 shows an exemplary workflow of the inventive method for monitoring an operationally correct manner of functioning of the control system of a plant in accordance with the invention.

### DETAILED DESCRIPTION OF THE EXEMPLARY EMBODIMENTS

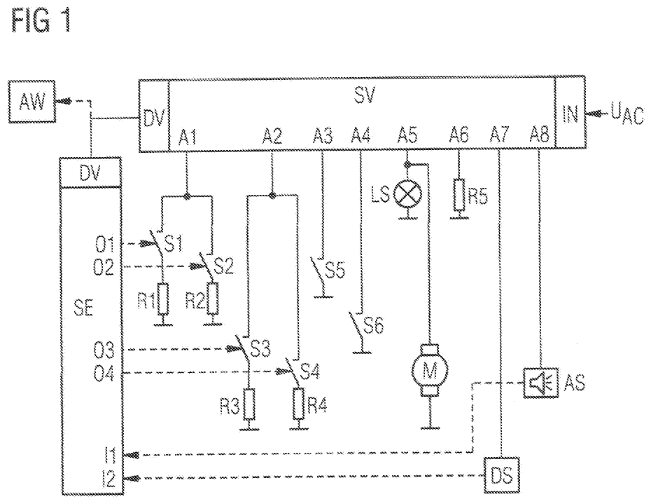

FIG. 1 shows, in a schematic and exemplary manner, a control system of a technical plant or of a complex machine. Here, the exemplary control system comprises at least one control unit SE, which may be formed as a programmable logic controller (PLC). Alternatively, a microcontroller or an industrial PC may be employed as a control unit SE. The control unit SE has, for example, digital outputs O1, . . . , O4 for actuating load units, i.e., in order to switch switching units S1, . . . , S4. Alternatively, the switching units S1, . . . , S4 may also be part of an output module of the control unit SE, in particular of a digital output module having a programmable logic controller or PLC. Alternatively or in addition, the control unit SE may also have analog outputs via which, e.g., actuator units or switching units can be connected for a control operation. For reasons of simplicity, the analog outputs of the control unit SE are not shown explicitly in FIG. 1. The digital outputs O1, . . . , O4 and the analog outputs afford the control unit SE the possibility to control and regulate the plant or machine via output signals primarily during operation. An operating state of the control system and consequently of the plant is produced during live operation via a combination of the output signals, primarily the output signals present at the digital outputs O1, . . . , O4. An operating state thus constitutes an operating condition of the control system or of the plant or machine that is predefined by the control unit SE via the output of predefinable output signals via the digital outputs O1, . . . , O4 and where applicable via analog outputs. However, an operating state of the control system or of the plant or machine may also be produced by the control unit SE, e.g., within the scope of a test phase via a test program in order to check, e.g., the plant or machine prior to its commissioning or deployment.

With the output signals, e.g., the switching units S1, S4 and load units R1, . . . , R4 associated therewith in the respective load circuits are switched accordingly. Further load units, such as actuator units (e.g., motor units or light signals), switching units (e.g. relays, solenoid valves or contactors), can be switched and/or controlled via analog outputs or their output signals.

In addition to the digital outputs O1, . . . , O4 and/or analog outputs, the control unit SE can also send output signals or control commands via an interface module DV for a data link to further units of the plant or machine, such as frequency converters, decentralized peripheral units (e.g., ET200 systems of the company Siemens). Control commands of the foregoing type can likewise provoke changes in the plant or in the machine that can be referred to alongside or in addition to the output signals of the digital outputs O1, . . . , O4 and/or of the analog outputs of the control unit SE in order to discriminate between operating states.

In addition, the control unit SE has, for example, digital inputs I1, I2 via which signals and/or parameter values of load units, in particular sensor units DS, AS, may be received. Events occuring at the present time in the plant or machine can be communicated to the control unit SE via the signals and/or parameter values received at the inputs I1, I2. With the signals and/or parameter values present at the inputs I1, I2, specific control and regulating operations can then be triggered, for example. The control unit SE may also have analog inputs for connecting and interrogating sensor units or their parameter values.

The exemplary control system further comprises a clocked power supply SV that is connected via an input side IN to a voltage supply UAC (e.g., a 3-phase alternating-current voltage). The power supply SV has, for example, eight outputs and consequently eight output channels A1, . . . , A8, to which the load circuits of the control system are connected, e.g., directly and via which the load circuits of the control system of the plant or the machine are supplied with a supply voltage (e.g., 24 V direct-current voltage) or with a supply current by the power supply SV. The power supply SV, such as the SITOP PSU8600 of the company Siemens, for example, can offer the possibility that the voltage value of the supply voltage delivered to the load circuit, as well as the current, can be set and monitored individually for each output channel A1, . . . , A8.

Alternatively, the control system may also have, e.g., a power supply SV to which e.g. an external module (e.g., an externally switchable protection unit) is connected that has at least two output branches which then form the at least two output channels A1, . . . , A8 for the power supply SV. These output branches or output channels A1, . . . , A8 are, e.g., separately switchable and the voltage value of the supply voltage delivered to the load circuit as well as the current can be set and monitored individually. The respective load circuits or the load units associated with the load circuits are then supplied with current or voltage via the output channels A1, . . . , A8.

Furthermore, the power supply SV and the control unit SE of the control system may have interface modules DV via which, e.g., a bidirectional data link for transferring control commands or signals and data information can be established. Profinet (Process Field Network), i.e., an open Industrial Ethernet standard of the PROFIBUS user organization for automation, may be used for the data link, for example. In addition, the data link DV may, for example, be used to transfer data, information and/or measurement values to an evaluation and/or data processing unit AW. The evaluation and/or data processing unit AW may be, for example, formed centrally and, e.g., collect and process data, information and/or measurement values from a plurality of plants or machines or their control systems.

A separate, dedicated power supply that is not shown in FIG. 1 may be provided for supplying a voltage to the control unit SE. Alternatively, the control unit SE may also be provided with the corresponding supply voltage by the clocked power supply SV of the control system. To this end, the control unit SE could, for example, be connected to a first output channel A1 of the power supply SV.

The load circuits of the control system of the plant or machine are connected to the output channels A1, . . . , A8 of the power supply SV, each of which may have at least one load unit, e.g., at least one actuator or switching unit or sensor unit. In the case of the exemplary control system shown in FIG. 1, switching units S1, S2, S3, S4 as well as associated load resistors R1, R2, R3, R4 are connected, for example, to the first output channel A1 and to a second output channel A2, which load resistors R1, R2, R3, R4 can be attached or detached via the respective switching unit S1, S2, S3, S4 and by corresponding output signals present at the respective digital outputs O1, O2, O3, O4 of the control unit SE. Further actuator or switching units S5, S6 (e.g. contactors, solenoid valves, relays, etc.) are likewise connected as load units to a third and fourth output channel A3, A4, e.g., for the purpose of switching on/off an electrical valve, a motor or a module for a drive controller. The actuator or switching units S5, S6 can be controlled, for example, by the control unit SE of the control system or by a further control unit, for example, via corresponding output signals. A light signal LS, for example, as well as a motor M e.g., for driving a fan unit are connected to a fifth output channel A5 of the power supply SV. A further load resistor R5, for example, is connected to a sixth output channel A6 of the power supply SV. The load units also can be controlled, for example, via analog outputs of the control unit SE and corresponding output signals (e.g., specification of a rotational speed value for the motor M, light signal LS on or off).

The respective operating state of the plant or machine is then produced during live operation (or by a test program in a test phase) by the combination of the output signals that are output by the digital outputs O1, . . . , O4 and the analog outputs of the control unit SE for controlling the respective load units in the respective load circuits. Depending on switched-on or attached and/or switched-off or detached load units, a supply current flows through the respective associated load circuits or a corresponding supply voltage is required. The current and/or voltage values can then be measured at the respective output channel A1, . . . , A6 of the respective load circuit.

Additionally connected as load unit to the seventh and eighth output channel A7, A8 is, e.g., a respective sensor unit DS, AS, by which, for example, a signal and/or parameter value is delivered to the corresponding digital input I1, I2 of the control unit SE. A pressure sensor DS, for example, is connected to the seventh output channel A7 in order to report a signal to the digital input I2 of the control unit SE as soon as a threshold value is reached. An acoustic signal unit AS, for example, is connected to the eighth output channel A8 in order to output a function signal to the digital input I1 of the control unit SE during the operation of the plant or machine. The latest signals or parameter values present at the inputs I1, I2 in the respective operating state (e.g., values of temperature sensor, pressure sensors or rotational speed sensors, function signals of proximity sensors, light signals or alarm signals) can additionally be acquired in an operating state and stored together with the latest current and voltage values that were measured for the respective operating state.

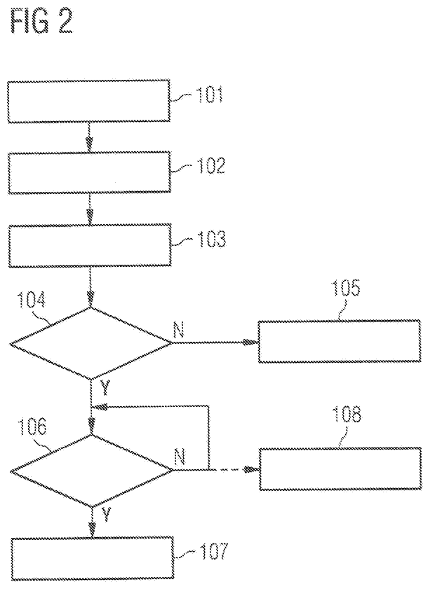

FIG. 2 shows by way of example a workflow of the inventive method for monitoring an operationally correct manner of functioning of a control system or of the associated load circuits of a plant as shown by way of example in FIG. 1.

When the method in accordance with the invention is implemented, it is detected in a monitoring step 101 during the ongoing operation of the plant or the machine, or during a test phase when the test program is executed, that there has been a change in the operating state of the control system. That is, the value in the case of at least one output signal of the control unit SE, which output signals are present at the outputs O1, . . . , O4 of the control unit SE, has been changed (e.g., a digital signal has changed from 0 to 1 or from 1 to 0) in at least one load circuit in order to switch or actuate at least one load unit. The change in operating state, in particular the detachment or attachment of a load unit, may result in a change in the current consumption or in the supply voltage in the associated load circuit.

In a measurement step 102, the latest current values and/or voltage values are therefore measured at the output channels A1, . . . , A8 of the power supply SV via which the respective load circuits are supplied with current and voltage. Ideally, a predefined or an individual waiting time for each measurement can be provided between the change in operating state and a measurement of the latest current and/or voltage values. As a result, fluctuations in current and/or voltage due to stabilization processes that may be produced in a load circuit, such as attachment or detachment of a load unit, are not included in the measurement, but rather maximally static or constant latest current and/or voltage measurement values are measured. Furthermore, it is possible to provide an averaging primarily of current measurement values over a predefinable integration time (e.g., 0.1 or 10 seconds) or another type of mathematical filtering in order to reduce current fluctuations and/or noise during the determination of the latest current measurement values. The filtering operations may also be applied to a plurality of current measurements taken in a predefined sequence in order to determine filtered measurement values at predefinable intervals (e.g., every 10 seconds) over a predefinable period of time (e.g. 1 minute) and in this way to be able to describe a stabilization process of a load unit or a power-consuming appliance.

In a storage step 103, the latest current and/or voltage measurement values measured for the respective latest operating state are stored. The respective latest operating state, i.e., the most recent combination of the output signals present at the outputs O1, . . . , O4 of the control unit SE, are also stored, e.g., in a database together with the latest recorded current and/or voltage measurement values. Here, the latest recorded current and/or voltage measurement values can be stored together with the respective latest operating state of the current and/or voltage measurement, e.g., in the control unit SE of the control system of the plant, in which case an evaluation of the measurement data or the further method steps can then be performed for example by the control unit SE.

Alternatively or in addition, the latest recorded current and/or voltage measurement values as well as the associated operating state can be transferred via a data link DV to a, e.g., centrally available evaluation and/or data processing unit AW and stored therein. The evaluation is then likewise performed, for example, by the evaluation and/or data processing unit AW. A start signal can be sent to the evaluation and/or data processing unit AW by the control unit SE prior to the transfer of the latest recorded current and/or voltage measurement values and the respective associated operating state. Thus, e.g., a stable measurement of the latest current and voltage values at the output channels following a change in operating state as well as a start of the data transfer can be communicated to the evaluation and/or data processing unit AW by the control unit SE. In particular, in the case of an online evaluation, the start signal can also notify the start of a further evaluation cycle to the evaluation and/or data processing unit AW. Ideally, a return signal can be sent to the control unit SE by the evaluation and/or data processing unit AW when the latter is ready for a next evaluation cycle.

In measurement step 102, in addition, each time a change in the operating state occurs, the inputs I1, I2 of the control unit SE, for example, can also be interrogated and the incoming signal and/or parameter values at the inputs can be stored together with the latest operating state and the latest recorded current and/or voltage values in storage step 103, such as in the control unit SE and/or in the evaluation and data processing unit AW. Furthermore, the latest values of environmental and/or plant parameters, such as temperature values, pressure values or rotational speed values, can also be determined in measurement step 102 and stored in storage step 103. These additional signal and parameter values or values of environmental and/or plant parameters can then be called upon in a comparison step 104 as secondary parameters for an additional filtering of comparison data for the latest recorded measurement values.

In comparison step 104, the latest recorded current and/or voltage measurement values are then compared with current and/or voltage values that were determined in at least one preceding measurement. The current and/or voltage values, which can likewise be stored, e.g., in the control unit SE and/or in the evaluation and/or data processing unit AW, may have been measured, e.g., on the same plant or on the same control system as the latest recorded current and/or voltage measurement values. Alternatively, the current and/or voltage values of preceding measurements may have been determined on plants or control systems of identical or similar design, such as in the case of series-produced plants and/or machines. In particular, when a plurality of plants or machines of identical or similar configurations are in operation in the field, a multiplicity of measurement data can be collected in this way.

In order to compare the latest recorded current and/or voltage measurement values with current and/or voltage values of at least one preceding measurement, it is also necessary in comparison step 104 to check whether the current and/or voltage values of the at least one preceding measurement were determined in an operating state which largely coincides with the operating states of the latest recorded current and/or voltage measurement data. For this purpose, a maximum permissible deviation may be predefined, for example, for an assessment of a correspondence of the operating state of the latest recorded current and/or voltage measurement data with the operating state of the current and/or voltage values of the at least one preceding measurement. That is, a check is performed to determine whether, e.g., the combination of the output signals of the control unit SE of the latest recorded measurement data corresponds except for the maximum permissible deviation with at least one of the output signal combinations that were stored for the data stored for preceding measurements. The maximum permissible deviation of the operating state can be dependent, e.g., on the size or complexity of the plant or the control system and/or on the number of possible operating states of a plant or machine. For complex plants or in the case of many possible operating states, e.g., deviations from one or more output signals may be permissible. In the case of small plants or a small number of possible operating states, e.g., an exact correspondence of the output signals may be required.

If no current and/or voltage values of preceding measurements having an operating state that corresponds in an appropriate manner with the operating state of the latest recorded current and voltage measurement values are found in comparison step 104, the method is exited in an exit step 105 and a further change in the operating state of the plant is awaited in monitoring step 101. The latest recorded current and voltage measurement values or the associated operating state may be flagged in the database as a new operating state at exit step 105, for example.

If a large number of current and/or voltage values of preceding measurements having an operating state that corresponds in an appropriate manner with the operating state of the latest recorded current and voltage measurement values are found in comparison step 104, then recourse may be had to the secondary parameters to provide additional filtering of the current and/or voltage values of preceding measurements. That is, the values of signals and/or parameters present at the inputs I1, I2 of the control unit SE that were determined for the respective current and/or voltage values and associated operating states, or values determined for environmental and/or plant parameters, are checked with the corresponding secondary parameters stored for the latest recorded measurement values to establish as great a correspondence as possible. Current and/or voltage values of preceding measurements that are then used for the comparison with the latest recorded current and/or voltage measurement values are those that not only have largely the same operating state but were also determined under maximally identical or very similar technical conditions of the plant and/or environmental conditions.

Once those current and/or voltage values of preceding measurements having the closest corresponding operating state and where applicable the best matching secondary parameters for the latest recorded current and/or voltage measurement values have been determined in comparison step 104, the latest recorded current and/or voltage measurement values are compared with the current and/or voltage values. That is, a search is conducted for those current and/or voltage values of preceding measurements that have the smallest deviations in the associated operating state and where applicable in the secondary parameters relative to the operating state and where applicable the secondary parameters of the latest recorded current and/or voltage measurement values. In a test step 106, a check is then performed to determine whether a predefined tolerance range is observed or exceeded based on the comparison of the latest recorded current and/or voltage measurement values with the current and/or voltage values of at least one preceding measurement in the corresponding operating state of the plant or the control system.

In this case, the predefined tolerance range can be specified, e.g., as a percentage or as an absolute range. A tolerance range for all load circuits of the plant or machine or for all measurement values (e.g., current, voltage) can be provided here, for example. However, it is also possible to specify tolerance ranges individually on a load-circuit-specific basis or to provide tolerance ranges for, e.g., identically or similarly implemented load circuits which can be selected, e.g., with the aid of the output channels A1, . . . , A8 at which the respective current and/or voltage values were determined. Furthermore, the tolerance range can be adjusted if, e.g., it is detected in the course of the inventive method or in the case of repeated application that the predefined tolerance range has been chosen, e.g., too narrowly or too broadly. If, e.g., too narrow a tolerance range is chosen, then false calls may be produced, for example, due to fluctuations in load circuits and/or, e.g., symptoms of aging in load units. That is, a fault is indicated in a load circuit in spite of the fact that the plant is operating correctly. If too wide a tolerance range is chosen, actually present malfunctions of load units may be overlooked, for example. An adjustment of the predefined tolerance range can be made, for example, based on current and/or voltage measurement values stored at different times.

If it is detected in test step 106 that the predefined tolerance range is not observed based on the comparison between the latest recorded current and/or voltage measurement values and the current and/or voltage values of at least one preceding measurement for the respective operating state, then the at least one load circuit in which the tolerance range is exited in the operating state of the latest recorded current and/or voltage measurement values is indicated in a display step 107. That is, it is possible, based on the respective output channel A1, . . . , A8 at which the respective current and/or voltage value showing a significant deviation from corresponding earlier measurement values was measured, to determine the load circuit affected in a given case and then to indicate the affected circuit. The display of the respective load circuit can be realized, e.g., via the control unit SE. A display unit assigned to the control unit SE, e.g., display or mobile display unit, can be used for this purpose.

When test step 106 is performed on an evaluation and/or data processing unit AW, the display of the respective load circuit in display step 107 can be realized, for example, via an output unit of the evaluation and/or data processing unit AW. Here, e.g., the latest recorded measurement values for current and/or voltage or current and/or voltage values of preceding measurements can be edited graphically, for example, in the form of tables or curves, and placed, e.g., in comparison with the latest recorded current and/or voltage measurement values.

It is also possible, for example, to connect multiple load units or power-consuming appliances to a load circuit (such as in FIG. 1 in the case of the load circuits that are connected to the first, second and fifth output channel A1, A2, A5). If there is a change in the operating states, then at least some of the load units can be, e.g., switched on/attached or switched off/detached by the control unit SE or modified in terms of their operating characteristics (e.g., change in the rotational speed of the motor M). This can result, in the case of at least one of the load units or power-consuming appliances, in a change in the current consumption. By measuring the latest current and/or voltage measurement values for the respective operating states that may be passed through for the load circuit or the associated output channel A1, A2, A5, it is possible, e.g., in test step 106 to determine those operating states in which the tolerance range was exited or exceeded in the load circuit. In display step 107, the corresponding operating state or states in which an exit or exceeding of the tolerance range was detected can then also be output, for example. In a further evaluation of the latest recorded current and/or voltage measurement values of the operating states and a determination of the load units that were active or switched on in the operating states, that load unit or those load units that triggered the exiting or exceeding of the tolerance range in the respective operating states can, for example, also be identified. A cause for the tolerance range being exited or exceeded can thus be confined at least to a small number of load units or power-consuming appliances. Ideally, the load unit at the root of the cause is discovered as a result.

If no exiting of the predefined tolerance range (i.e., exceeding or undershooting in terms of absolute value or percentage) is detected in test step 106 by the comparison between the latest recorded measurement values for current and/or voltage and current and/or voltage values of at least one earlier measurement, then the method in accordance with the disclosed embodiments of the invention is terminated with a termination step 108. In termination step 108, an output, e.g., indicating that no anomalous conditions could be detected in the tested load circuits of the plant or machine, can be generated.

It is furthermore noted that the method in accordance with the disclosed embodiments of the invention may be used not only with clocked/switched-mode power supplies SV by which an alternating-current voltage applied on the input side is converted into a constant direct-current output voltage. The method in accordance with the disclosed embodiments of the invention may also be applied, e.g., in the case of regulated voltage supplies for alternating-current load units and consequently for a large range of power-consuming appliances for checking said load units for correct wiring or correct manner of operation.

Thus, while there have been shown, described and pointed out fundamental novel features of the invention as applied to a preferred embodiment thereof, it will be understood that various omissions and substitutions and changes in the form and details of the methods described and illustrated, and in their operation, may be made by those skilled in the art without departing from the spirit of the invention. For example, it is expressly intended that all combinations of those method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for monitoring an operationally correct functioning of a plant control system, the control system comprising, in addition to at least two load circuits, at least one control unit and a clocked power supply via which the at least two load circuits, each having at least one load unit, are supplied with at least one of (i) a supply voltage and (ii) a supply current via at least two output channels, different operating states being assumed by the control system while said control system functions in an operationally correct manner, and an operating state being caused by a combination of output signals of the control unit, the method comprising:
detecting a change in the operating state of the control system;
measuring at least one of (i) the respective latest current and (ii) voltage values at each of the at least two output channels for respective associated load circuits;
storing at least one of the (i) respective latest recorded current and (ii) voltage measurement values together with the respective operating state of the control system;
comparing at least one of (i) the respective latest recorded current and (ii) voltage measurement values with at least one of current and voltage values of at least one preceding measurement, recourse being had only to at least one of current and/or voltage values of at least one preceding measurement whose respective operating state reveals a correspondence with the respective operating state of at least one of (i) the respective latest recorded current and (ii) voltage measurement values;
checking whether a predefined tolerance range is exited based on the comparison of at least one of (i) the latest recorded current and (ii) voltage measurement values with at least one of the current and voltage values of the at least one preceding measurement; and
displaying the respective load circuit in which the predefined tolerance range is exited in the respective operating state of at least one of (i) the latest recorded current and (ii) voltage measurement values.

2. The method as claimed in claim 1, wherein at least one of:
(A) at least one of (i) respective latest values of parameters and (ii) signals at signal inputs of the control unit are acquired and stored in addition to at least one of (i) the latest recorded current and (ii) voltage measurement values of the respective operating state and
(B) latest values of environmental and plant parameters are acquired and stored in addition to at least one of (i) the latest recorded current and (ii) voltage measurement values of the respective operating state.

3. The method as claimed in claim 1, wherein a maximum permissible deviation is predefined for an assessment of the correspondence between the respective operating state of at least one of (i) the latest recorded current and (ii) voltage measurement data and the operating state of at least one of the current and voltage values of at least one preceding measurement.

4. The method as claimed in claim 2, wherein a maximum permissible deviation is predefined for an assessment of the correspondence between the respective operating state of at least one of (i) the latest recorded current and (ii) voltage measurement data and the operating state of at least one of the current and voltage values of at least one preceding measurement.

5. The method as claimed in claim 1, wherein the predefined tolerance range for the comparison of at least one of (i) the latest recorded current and (ii) voltage measurement values with at least one of the current and voltage values of at least one preceding measurement in the respective operating state is adjustable.

6. The method as claimed in claim 1, wherein following detection of the change in operating state, a predefinable waiting time is provided prior to measurement of at least one of (i) the respective latest current and (ii) voltage values at the at least two output channels.

7. The method as claimed in claim 1, wherein following detection of the change in operating state, the respective latest current value is measured at the at least two output channels at predefinable intervals within a predefinable time period; and
wherein an average value is formed from the current values measured in the predefinable time period as the latest recorded current measurement value for the respective operating state.

8. The method as claimed in claim 1, wherein at least one of the (i) current and (ii) voltage values of the at least one preceding measurement are measured on the same plant or on the same control system as at least one of (i) the latest recorded current and (ii) voltage measurement values.

9. The method as claimed in claim 1, wherein at least one of the (i) current and (ii) voltage values of the at least one preceding measurement are measured on one of (i) a plant of identical or similar configuration and (ii) a control system of identical or similar configuration.

10. The method as claimed in claim 1, wherein at least one of (i) the measured current and (ii) voltage values are stored in the control unit together with respective associated operating states.

11. The method as claimed in claim 1, wherein at least one of (i) the measured current and (ii) voltage values are transferred to an evaluation and/or data processing unit together with the respective associated operating states and stored therein.

12. The method as claimed in claim 11, wherein a start signal is sent to the evaluation and/or data processing unit by the control unit prior to a transfer of at least one of (i) the latest recorded current and (ii) voltage measurement values together with the respective associated operating state.

13. The method as claimed in claim 11, wherein a return signal is sent to the control unit by the evaluation and/or data processing unit.

14. The method as claimed in claim 12, wherein a return signal is sent to the control unit by the evaluation and/or data processing unit.

15. The method as claimed in claim 1, wherein said method is performed during ongoing operation of the plant.

16. The method as claimed in claim 1, wherein said method is performed in a test phase as a test program; and wherein predefined operating states are invoked to measure at least one of (i) the latest current and (ii) voltage measurement values.
